(19) United States
(12) Patent Application Publication
(10) Pub. No.: US 2016/0371953 A1
(43) Pub. Date: Dec. 22, 2016

(54) SYSTEM AND METHOD OF USE FOR CHILD DISCIPLINE

(71) Applicants: Ines Moreno, Ocala, FL (US); Javier Moreno, Ocala, FL (US)

(72) Inventors: Ines Moreno, Ocala, FL (US); Javier Moreno, Ocala, FL (US)

(21) Appl. No.: 15/254,444

(22) Filed: Sep. 1, 2016

Related U.S. Application Data
(63) Continuation-in-part of application No. 14/733,622, filed on Jun. 8, 2015, now abandoned.

(51) Int. Cl. G08B 21/18

(52) U.S. Cl. CPC G08B 21/18

(57) ABSTRACT

A child discipline system designated as a punishment tool that includes the use of a pad with an alarm system that is designated as a punishment position for the child. Within the pad is a sensor that detects whether the child is sitting on the pad and creates a system where if a child moves the sensor activates the alarm indicating that the child has moved from their punishment spot. A receiver is used with the pad that receives an alert from the alarm therefore freeing the parent or guardian from actively monitoring the child in their punishment position.

### CROSS REFERENCE TO OTHER APPLICATIONS

This application is a continuation in part to U.S. patent application Ser. No. 14/733,622 filed on Jun. 8, 2015.

### BACKGROUND OF THE INVENTION

Field of the Invention

A present invention relates to a system for a child discipline system to assist in administering a disciplinary action to a child.

Description of Related Art

One common method of disciplining a child involves forcing the child to sit in a solitary place for a predetermined amount of time. Children enjoy constant running, jumping and playing at a certain age therefore forcing a child to sit in a corner or otherwise is used as a means of punishment for inappropriate behavior. In order to enforce this punishment the parent or guardian must monitor the child while the child is in this period of punishment, i.e. time out. During this punishment period if the child is not monitored they may move from their designated punishment spot or avoid the punishment if not properly enforced by the parent. As a consequence, it would be advantageous to have a system that assists the parent in monitoring the punishment of the child.

### SUMMARY OF THE INVENTION

In view of the foregoing disadvantages inherent in the prior art, the general purpose of the present invention is to provide a child discipline system, configured to include all of the advantages of the prior art, and to overcome the drawbacks inherent therein.

The present invention relates to a child discipline system that includes the use of a pad with an alarm system that is designated as a punishment position for the child. Within the pad is a sensor that detects whether the child is sitting on the pad and creates a system where if a child moves the sensor activates the alarm indicating that the child has moved from their punishment spot. A receiver is used with the pad that receives an alert from the alarm therefore freeing the parent or guardian from actively monitoring the child in their punishment position. Further the receiver includes a key pad that remotely deactivates the alarm for the user after receiving notice that the child has moved from their designated spot punishment.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a child discipline system in accordance with an exemplary embodiment of the present invention.

FIG. 2 depicts an alarm receiver for the child discipline system according to the present invention.

### DETAILED DESCRIPTION OF THE DRAWINGS

The present invention relates to a child discipline system to notify a parent or guardian when their child or infant is moved or lifted from a particular location. The present invention consists of a pad with an electronic sensor and an alarm receiver. During use the parent or guardian places the child on the pad, which activates the electronic sensor. If the child moves, then the sensor activates the alarm receiver, which either sounds a noise, flashes a light or both to alert the parent that the child has moved from the pad. The parent or guardian may monitor their child without visual contact. The discipline system therefore helps to enforce the child discipline as required.

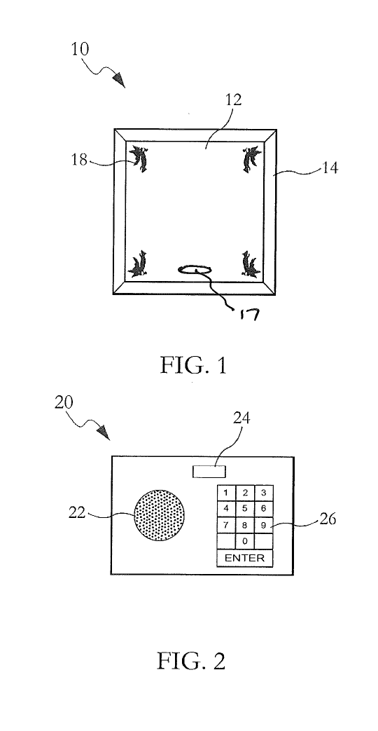

Tuning now descriptively to the drawings, referring to FIG. 1, a perspective view of a child discipline system (10) is shown in accordance with an exemplary embodiment of the present invention. The child discipline system (10) includes a pad (12) as a surface which to place a child for punishment. The pad (12) may be placed on a floor or playpen. The pad (12) may include a layer of padding to provide greater comfort for the child while resting on the pad (12). The pad (12) may have a square (as shown), circular or rectangular shape. The pad (12) may have a rubber base to ensure that it does not slide once the infant is placed upon the top surface. The top surface may be covered with a felt, cloth, or quilted material to provide greater comfort against the infant's skin. Around the peripheral portions of the pad (12) is an edge (14). The edge (14) may be angled sloping down to rest against the sides of the crib or playpen. Alternatively, the edge (14) may slope up creating a lip to ensure that the baby remains on the pad (12).

Within the pad (12) may be an electronic weight sensor or motion sensor to detect when the child is on the pad (12). The weight sensor is activated when the child is placed on the pad (12) and detects if the child moves. The weight sensor monitors the weight of the child and activates an alarm is the child moves from the pad. A signal alerts the user that the child is no longer on the pad (12). The weight sensor sends the signal to an alarm receiver (20), described further below. The weight sensor may be battery operated to ensure that there are no hanging cords or wires that may become choking hazards for the infant.

As an additional component of the child discipline system (10) is the alarm receiver (20), as shown in FIG. 2. The alarm receiver (20) may be a remote device to be placed in a location of the user's choosing. Further the alarm receiver (20) may be a portable handheld device for the user. The alarm receiver (20) may include a speaker (22) to sound a noise when the alarm is activated within the weight sensor. Additionally, the alarm receiver (20) may include a light (24), which may flash when the alarm is activated. The light (24) may be used along, and may prove more desirable for use if others in the house are napping or sounds would be inconvenient during use. Therefore, the alarm receiver (20) may include a switch to choose between the speaker (22), the light (24) or both to notify the user.

Once the alarm receiver is activated and the user is notified, either with the speaker (22) or the light (24), the user may turn off the alarm receiver (20) by entering a deactivation code into a keypad (26). The keypad (26) ensures that only the user is deactivating the alarm receiver (20). In this fashion, the user is sure to notice when the alarm is sounded, and the code ensures that a stranger cannot deactivate the alarm.

The pad (12) creates a designated area for discipline enforcement. This discipline enforcement therefore will be associated with the pad in the child's mind. The pad (12) includes four corners as indicated by the insignias 18 at each corner. The insignias 18 provide locations for the weight sensors associated with the present invention. Within the border 14 is a speaker 17. Speaker 17 allows the user to transmit audio messages to the child while the child is on the punishment pad 12. During operation should the child move from the pad 12, the alarm receiver 20 receives an alert from the weight sensors in the pad 12 activating an alarm on the alarm receiver 20. Further an audio alert may be provided to the child to remain on the pad 12. Upon receipt of the alarm the parent may further send an audio message to the pad for playback on the speaker 17 directing the child to go back into position onto the pad 12. As a consequence, the user may use this pad and system to ensure that the child remains on the pad 12 during the punishment period.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for child disciple comprising:
a. a pad, where the pad includes a surface for child placement;
b. a sensor within the pad, where the sensor detects weight and is activated upon placement of a child onto the pad;
c. an alarm receiver, where the alarm receiver receives transmissions from the sensor within a pad activating an alarm on the receiver upon movement of the child from the pad;
d. a speaker within the pad wherein said speaker is capable of audio transmissions; and
e. a keypad on said alarm receiver, where said pad enables user inactivity with the pad.

2. A method of child disciple comprising of the following steps:
a. placing a child on a pad, wherein the pad includes a weight sensor activated upon placement of the child on the pad;
b. actively monitoring of pad activity through the use of a alarm receiver;
c. transmitting audio messages to a child via a speaker within the pad; and
d. controlling activity related to the pad to the alarm receiver.
